(19) United States
(12) Patent Application Publication
(10) Pub. No.: US 2026/0244467 A1
(43) Pub. Date: Aug. 20, 2026

(54) METHOD FOR PROVIDING INTERACTIVE ASSISTANCE, HOST, AND COMPUTER READABLE STORAGE MEDIUM

(71) Applicant: HTC Corporation, Taoyuan City (TW)

(72) Inventor: Chang-Chen Yao, Taoyuan City (TW)

(73) Assignee: HTC Corporation, Taoyuan City (TW)

(21) Appl. No.: 19/056,700

(22) Filed: Feb. 18, 2025

(51) Int. Cl. G06F 9/451; G06F 3/16

(52) U.S. Cl. CPC G06F 9/453; G06F 3/167

(57) ABSTRACT

The embodiments of the disclosure provide a method for providing interactive assistance, a host, and a computer readable storage medium. The method includes: displaying a visual content, wherein the visual content includes at least one content area; determining an interactive behavior of an input indicator to the visual content; determining a first content area currently interacting with the input indicator among the at least one content area; in response to determining that a first combination of the interactive behavior of the input indicator and the first content area corresponds to a first predetermined combination among a plurality of predetermined combinations, retrieving a first assisting suggestion corresponding to the first predetermined combination; and triggering a virtual assistant to provide the first assisting suggestion.

### BACKGROUND

### 1. Field of the Invention

The present disclosure generally relates to a mechanism for providing assistance, in particular, to a method for providing interactive assistance, a host, and a computer readable storage medium.

### 2. Description of Related Art

In XR (Extended Reality), the mechanism for triggering virtual assistant services primarily relies on multimodal input and contextual awareness technologies. Users can activate the virtual assistant through various methods, such as voice commands, gestures, eye tracking, or controller inputs.

For example, saying a wake word like “Hey Assistant” or making a specific gesture pointing to an object can prompt the assistant to respond. Meanwhile, sensors and AI capabilities built into XR devices analyze the user's virtual or physical environment, ensuring the assistant's responses are highly relevant to the current context.

This indicates that current XR systems primarily rely on user-initiated triggers for virtual assistants, such as voice commands or gesture inputs. This design limits the intelligence of the assistant, as the system rarely actively perceives user needs or predicts intentions. As a result, the interaction experience leans more toward passive responses rather than truly intelligent, proactive services.

### SUMMARY OF THE INVENTION

Accordingly, the disclosure is directed to a method for providing interactive assistance, a host, and a computer readable storage medium, which may be used to solve the above technical problems.

The embodiments of the disclosure provide a method for providing interactive assistance, executed by a host. The method includes: displaying a visual content, wherein the visual content includes at least one content area; determining an interactive behavior of an input indicator to the visual content; determining a first content area currently interacting with the input indicator among the at least one content area; in response to determining that a first combination of the interactive behavior of the input indicator and the first content area corresponds to a first predetermined combination among a plurality of predetermined combinations, retrieving a first assisting suggestion corresponding to the first predetermined combination; and triggering a virtual assistant to provide the first assisting suggestion.

The embodiments of the disclosure provide a host including a storage circuit and a processor. The storage circuit stores a program code. The processor is coupled to the storage circuit and accesses the program code to perform: displaying a visual content, wherein the visual content includes at least one content area; determining an interactive behavior of an input indicator to the visual content; determining a first content area currently interacting with the input indicator among the at least one content area; in response to determining that a first combination of the interactive behavior of the input indicator and the first content area corresponds to a first predetermined combination among a plurality of predetermined combinations, retrieving a first assisting suggestion corresponding to the first predetermined combination; and triggering a virtual assistant to provide the first assisting suggestion.

The embodiments of the disclosure provide a computer readable storage medium, the computer readable storage medium recording an executable computer program, the executable computer program being loaded by a host to perform steps of: displaying a visual content, wherein the visual content includes at least one content area; determining an interactive behavior of an input indicator to the visual content; determining a first content area currently interacting with the input indicator among the at least one content area; in response to determining that a first combination of the interactive behavior of the input indicator and the first content area corresponds to a first predetermined combination among a plurality of predetermined combinations, retrieving a first assisting suggestion corresponding to the first predetermined combination; and triggering a virtual assistant to provide the first assisting suggestion.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the disclosure.

FIG. 1 shows a schematic diagram of a host according to an embodiment of the disclosure.

FIG. 2 shows a flow chart of the providing interactive assistance according to an embodiment of the disclosure.

FIG. 3A to FIG. 3D show schematic diagrams of the visual content according to an embodiment of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

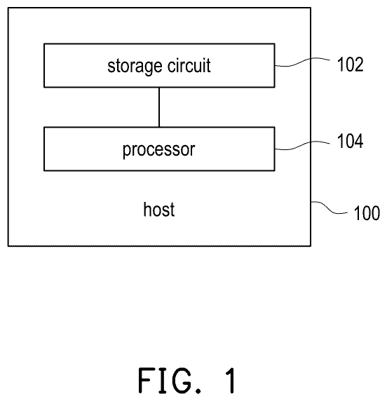

See FIG. 1, which shows a schematic diagram of a host according to an embodiment of the disclosure. In various embodiments, the host 100 can be any smart device and/or computer device that can provide visual contents of reality services such as virtual reality (VR) service, augmented reality (AR) services, mixed reality (MR) services, and/or extended reality (XR) services, but the disclosure is not limited thereto. In some embodiments, the host 100 can be a head-mounted display (HMD) capable of showing/providing visual contents (e.g., AR/VR/MR contents) for the wearer/user to see.

In one embodiment, the host 100 can be disposed with built-in displays for showing the visual contents for the user to see. Additionally or alternatively, the host 100 may be connected with one or more external displays, and the host 100 may transmit the visual contents to the external display(s) for the external display(s) to display the visual contents, but the disclosure is not limited thereto.

In FIG. 1, the host 100 includes a storage circuit 102 and a processor 104. The storage circuit 102 is one or a combination of a stationary or mobile random access memory (RAM), read-only memory (ROM), flash memory, hard disk, or any other similar device, and which records a plurality of modules that can be executed by the processor 104.

The processor 104 may be coupled with the storage circuit 102, and the processor 104 may be, for example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, a graphic processing unit (GPU), and the like.

In the embodiments of the disclosure, the processor 104 may access the modules and/or program codes stored in the storage circuit 102 to implement the method for providing interactive assistance proposed in the disclosure, which would be further discussed in the following.

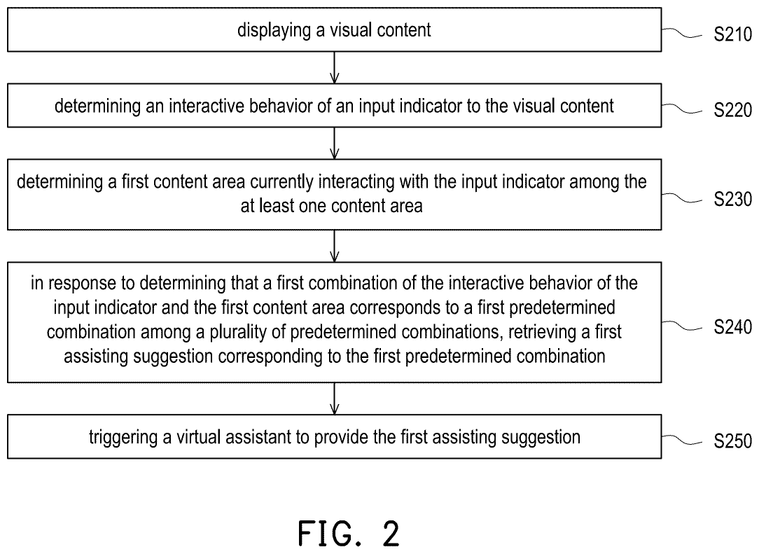

See FIG. 2, which shows a flow chart of the providing interactive assistance according to an embodiment of the disclosure. The method of this embodiment may be executed by the host 100 in FIG. 1, and the details of each step in FIG. 2 will be described below with the components shown in FIG. 1.

In step S210, the processor 104 displays a visual content, wherein the visual content includes at least one content area.

In some embodiments, the visual content may be various content displayed by the processor 104. In the embodiments where the host 100 is an HMD for providing reality services, the visual content may be, for example, AR/VR/MR contents, but the disclosure is not limited thereto.

In various embodiments, the at least one content area may include, but not limited to, at least one of an application library, a wireless network status bar, a Bluetooth status bar, a computing device connection status bar, a navigation panel button bar, an accessory status bar, a main field of a setting page, a subfield of the setting page, a store page, and a product description field.

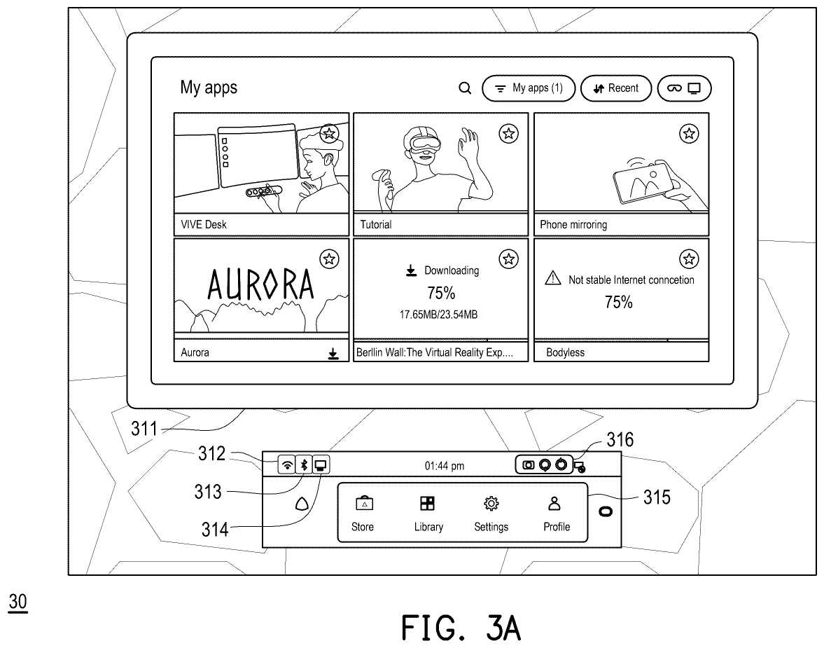

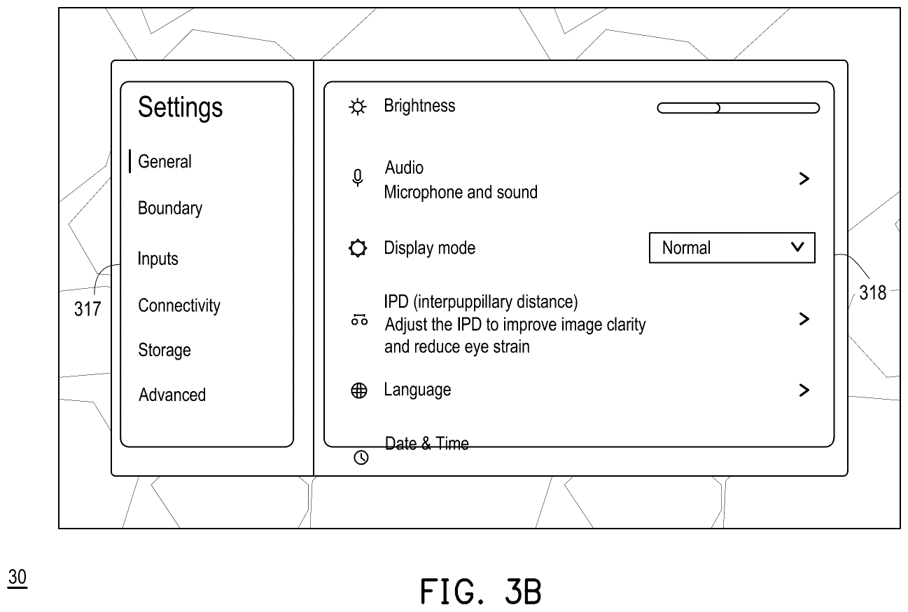

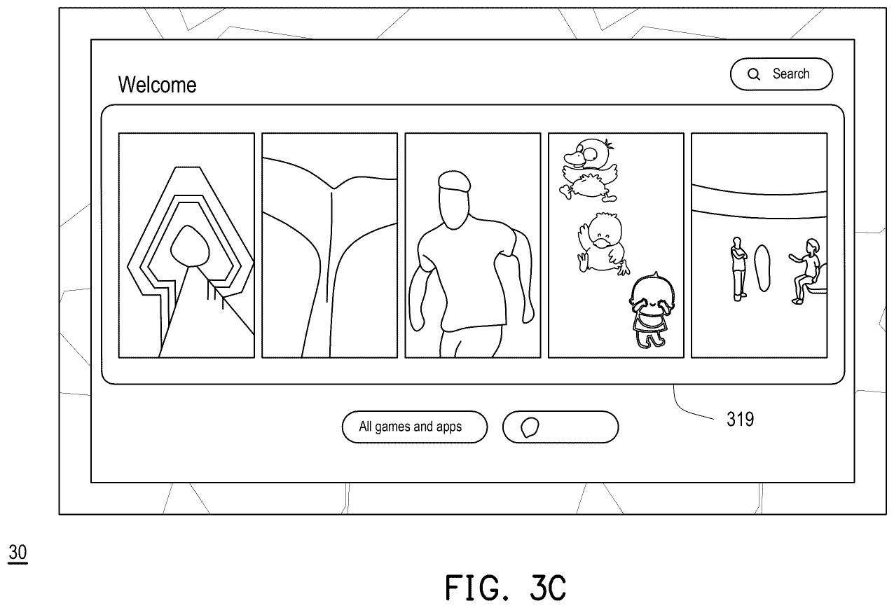

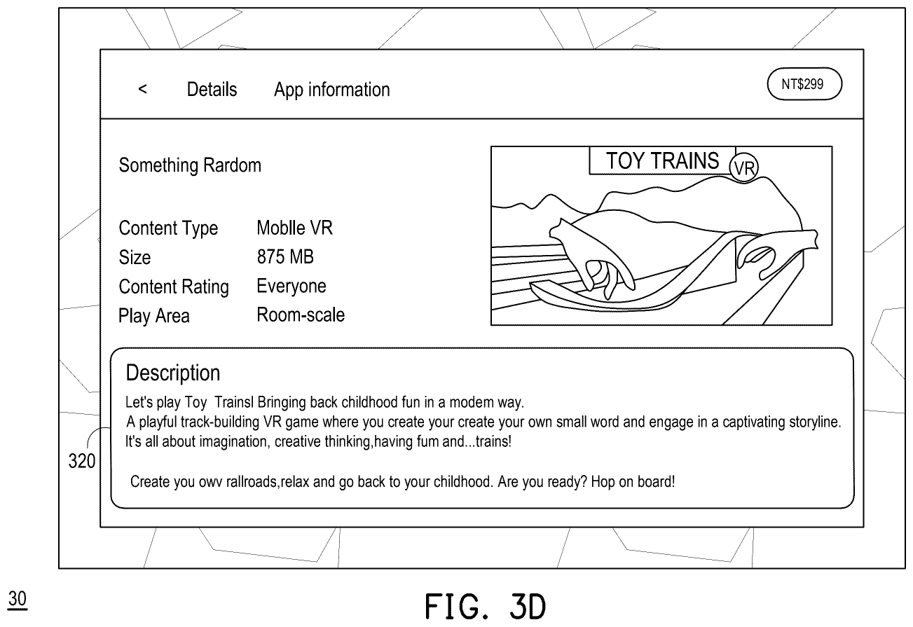

For better understanding, FIG. 3A to FIG. 3D would be used as an example, but the disclosure is not limited thereto.

See FIG. 3A to FIG. 3D, which show schematic diagrams of the visual content according to an embodiment of the disclosure.

In FIG. 3A, the visual content 30 may be, for example, a VR content displayed by the host 100 (e.g., HMD), wherein the visual content 30 may include content areas 311-316.

In the embodiment, the content area 311 may be an application library that includes a plurality of applications selectable by the user. The content area 312 may be a wireless network status bar that indicates the wireless network status of the host 100. The content area 313 may be a Bluetooth status bar that indicates the Bluetooth status of the host 100. The content area 314 may be a computing device connection status bar that indicates whether the host 100 is connected to an external computing device (e.g., a personal computer). The content area 315 may be a navigation panel button bar that includes different buttons for activating different functions. The content area 316 may be an accessory status bar that indicates the statuses of the accessory devices of the host 100, but the disclosure is not limited thereto.

In FIG. 3B, the content area 317 may be a main field of a setting page that include several buttons for different system settings. The content area 318 may be a subfield of the setting page that shows some specific settings under a particular system setting.

In FIG. 3C, the content area 319 may be a store page, which may show different products that can be purchased in the reality service.

In FIG. 3D, the content area 320 may be a product description field, which shows the descriptions associated with one particular product in FIG. 3C, but the disclosure is not limited thereto.

In step S220, the processor 104 determines an interactive behavior of an input indicator to the visual content 30.

In various embodiments, the input indicator may be a visual cue or signal that represents the user's input status or interaction, such as a cursor and/or a raycast. In some embodiments, the input indicator may include: controller indicators, which show actions performed with handheld controllers (e.g., VR controllers), such as button presses or joystick movements; hand tracking indicators, which display gestures like tapping, grabbing, or swiping when using hand tracking features; voice input indicators, such as microphone icons or wave animations, to signal that voice input is being received or processed; eye tracking indicators, which highlight the user's gaze point or selection area in eye-tracking interactions; virtual keyboard indicators, showing the current focus or input location, like a cursor or key highlight during text input; and activation indicators, signaling that a function is being triggered or input has been received, often through icons or color changes during object selection or drag-and-drop actions, but the disclosure is not limited thereto.

In some embodiments, the interactive behavior may be the way the input indicator interacts with the visual content, which may include, but not limited to, at least one of staying, a point-to-point movement, a back-and-forth dragging movement, a movement with a fixed pattern.

In step S230, the processor 104 determines a first content area currently interacting with the input indicator among the at least one content area.

For example, if the input indicator (e.g., a raycast corresponding to the user's input operation) is determined to be performing an interactive behaviour (e.g., a back-and-forth dragging movement) to the content area 31, the processor 104 may determine that the content area 31 as the first content area considered in step S230. For another example, if the input indicator (e.g., an eye gaze of the user) is determined to be performing an interactive behaviour (e.g., staying) to the content area 32 the processor 104 may determine that the content area 32 as the first content area considered in step S230, but the disclosure is not limited thereto.

In one embodiment, the processor 104 may determine whether a first combination of the interactive behavior of the input indicator and the first content area corresponds to a first predetermined combination among a plurality of predetermined combinations.

In step S240, in response to determining that a first combination of the interactive behavior of the input indicator and the first content area corresponds to a first predetermined combination among a plurality of predetermined combinations, the processor 104 retrieves a first assisting suggestion corresponding to the first predetermined combination.

In different embodiments, each of the predetermined combination may correspond to a specific combination of a specific interactive behavior of the input indicator and a specific content area. In addition, each of the predetermined combination may be designed with a corresponding specific assisting suggestion, wherein the specific assisting suggestion corresponding to each predetermined combination may be pre-programmed by the developers and/or generated by artificial models based on the corresponding predetermined combination.

In this case, the processor 104 may determine whether the above first combination corresponds to (e.g., match, same as) any of the predetermined combinations. If the processor 104 determines that the first combination corresponds to one of the predetermined combinations, the processor 104 may determine the one of the predetermined combinations as the first predetermined combination considered in step S240, and the specific assisting suggestion corresponding to the first predetermined combination may be determined to be the first assisting suggestion considered in step S240.

In some embodiments, several predetermined combinations and the corresponding assisting suggestion may be exemplarily shown in the following Table 1.

TABLE 1

| | Case1 | Case 2 | Case 3 | Case4 | Case 5 |
|---|---|---|---|---|---|
| interactive | back-and- | point-to- | point-to-point | point-to-point | moving with a |
| behavior of | forth | point | movement | movement | fixed pattern |
| the input | dragging | movement | | | |
| indicator | movement | | | | |
| first content | application | navigation | main field of a | store page | product |
| area | library | panel | setting page or | | description field |
| | | button bar | subfield of the | | |
| | | | setting page | | |
| explanation | None | Direct the | The input | Direct the input | If the position of |
| | | input | indicator moves | indicator to a | the input indicator |
| | | indicator to | between two | certain number | moves regularly |
| | | the four | blocks' buttons a | of product UIs | from left to right |
| | | buttons on | certain number | within a certain | |
| | | the | of times without | time | |
| | | navigation | triggering | | |
| | | panel | functions (e.g., | | |
| | | within a | adjusting | | |
| | | certain | volume, | | |
| | | time | changing | | |
| | | | brightness, etc.) | | |
| assisting | “Hi, I can | “Are you | “Hi, I can help | “Hey, what | “Hey, I can |
| suggestion | help you | looking for | you perform the | kind of app are | introduce this app |
| | start the | a specific | settings you | you interested | to you if you |
| | app. If you | page? You | want or open a | in? Maybe you | need.” |
| | need, you | can open it | certain page. If | can chat with | |
| | can tell me | via voice.” | you need | me about it.” | |
| | the name | | anything, you | | |
| | of the | | can tell me.” | | |
| | application | | | | |
| | you want | | | | |
| | to start.” | | | | |

In the example of Table 1, if the processor 104 determines the interactive behavior of the input indicator is “back-and-forth dragging movement” and the first content area is “application library”, the processor may determine the first combination thereof corresponds to Case 1 in Table 1. In this case, the processor 104 may determine the first assisting suggestion to be “Hi, I can help you start the app. If you need, you can tell me the name of the program you want to start.”

In addition, if the processor 104 determines the interactive behavior of the input indicator is “point-to-point movement” and the first content area is “navigation panel button bar”, the processor may determine the first combination thereof corresponds to Case 2 in Table 1. In this case, the processor 104 may determine the first assisting suggestion to be “Are you looking for a specific page? You can open it via voice.”

Based on the above explanation, a person skilled in the art should be able to correspondingly derive the first assisting suggestion corresponding to other variants of the first combination.

In step S250, the processor 104 triggers a virtual assistant to provide the first assisting suggestion.

In one embodiment, the triggered virtual assistant may provide the first assisting suggestion via a voice message and/or text hint, but the disclosure is not limited thereto.

In some embodiments, once the virtual assistance is triggered, the processor 104 may further display the avatar corresponding to the virtual assistant in the visual content while providing the first assisting suggestion, but the disclosure is not limited thereto.

In a first embodiment, the first assisting suggestion may suggest to execute a first function, and the user may provide a response to the first assisting suggestion to indicate whether the user agrees to execute the first function.

In one embodiment, the user may verbally provide a confirmative response (e.g., say “yes”) to the first assisting suggestion if the user agrees to execute the first function. Otherwise, the user may verbally provide a declining response (e.g., say “no”) to the first assisting suggestion if the user disagrees to execute the first function, but the disclosure is not limited thereto.

In one embodiment, in response to detecting a confirmative response to the first assisting suggestion, the processor 104 may accordingly execute the first function suggested by the first assisting suggestion.

In one embodiment, the first function may indicate launching a target application. For example, the virtual assistant may ask, via the first assisting suggestion, the user if the user wants to launch a target application (e.g., a browser) if the determined first combination shows that the user may intend to launch the target application. In this case, the user may say “yes”, and the processor 104 may determine that a confirmative response to the first assisting suggestion has been detected. Accordingly, the processor 104 may execute the first function by launching the target application.

In a second embodiment, the virtual assistant may ask, via the first assisting suggestion, the intention of the user, and the user may verbally say describe the intention thereof. In this case, the processor 104 may determine that an intention response to the first assisting suggestion has been detected, and the processor 104 may execute a second function corresponding to the intention response.

For example, if the considered first assisting suggestion is the assisting suggestion of Case 1 in Table 1, the user may say the name of the desired application. In this case, the processor 104 may accordingly execute the second function by launching the associated application.

For another example, if the considered first assisting suggestion is the assisting suggestion of Case 2 in Table 1, the user may say the name of the desired page. In this case, the processor 104 may accordingly execute the second function by showing the associated page.

As can be seen from the above, the embodiments of the disclosure provide a solution to proactively trigger the virtual assistant to assist the user, which improves the operational convenience, thereby improving user experience.

In other embodiments, other than considering factors such as the interactive behavior of the input indicator and the first content area, some predetermined combinations may further take additional factors into consideration.

For example, the additional factors may include the device status of the host 100. In this case, the associated predetermined combinations may be shown in the following Table 2.

In a third embodiment, several predetermined combinations and the corresponding assisting suggestion may be exemplarily shown in the following Table 1.

TABLE 2

| | Case 6 | Case 7 |
|---|---|---|
| interactive behavior of the | staying | staying |
| input indicator | | |
| first content area | wireless network status bar | accessory status bar |
| device status | wireless network not connected | device controller not |
| | | connected |
| assisting suggestion | “Do you need help opening the | “Hey, it seems you're not |
| | Wi-Fi settings page?” | connected to the controller. |
| | | Do you need help starting the |
| | | pairing process?” |

In one embodiment, after performing step S230, the processor 104 may further determine whether the first content area corresponds to a device status indicator of the host 100.

In the embodiment, the device status indicator of the host 100 may indicate the operational status and connectivity of the device. These indicators may include power status (such as on or off), connection status (such as whether it is connected to a computer or wireless network), battery level (such as charging or low battery), and the status of other important functions, such as whether the tracking system is functioning correctly or if updates are available. These indicators are usually displayed through lights, color changes, or graphics, helping users quickly understand the current status of the device for necessary actions or troubleshooting.

In the scenario of FIG. 3A, the device status indicator of the host 100 may include the wireless network status indicator in the content area 312, the Bluetooth status indicator in the content area 313, and the accessory status indicator in the content area 316, but the disclosure is not limited thereto.

In one embodiment, in response to determining that the first content area corresponds to a device status indicator of the host 100, the processor 104 may read a device status corresponding to the device status indicator.

For example, if the considered first content area is the content area 312, the processor 104 may read the wireless network status of the host 100. If the considered first content area is the content area 313, the processor 104 may read the Bluetooth status of the host 100. If the considered first content area is the content area 316, the processor 104 may read the accessory status of the host 100, but the disclosure is not limited thereto.

Afterwards, the processor 104 may determine whether a second combination of the interactive behavior of the input indicator, the first content area, and the device status corresponds to a second predetermined combination among the plurality of predetermined combinations.

In the third embodiment, each of the predetermined combination may correspond to a specific combination of a specific interactive behavior of the input indicator, a specific device status of the host 100, and a specific content area. In addition, each of the predetermined combination may be designed with a corresponding specific assisting suggestion, wherein the specific assisting suggestion corresponding to each predetermined combination may be pre-programmed by the developers and/or generated by artificial models based on the corresponding predetermined combination.

In this case, the processor 104 may determine whether the above second combination corresponds to (e.g., match, same as) any of the predetermined combinations. If the processor 104 determines that the second combination corresponds to one of the predetermined combinations, the processor 104 may determine the one of the predetermined combinations as the second predetermined combination considered in the third embodiment, and the specific assisting suggestion corresponding to the second predetermined combination may be determined to be the second assisting suggestion considered in the third embodiment.

In the example of Table 2, if the processor 104 determines the interactive behavior of the input indicator is “staying”, the first content area is “wireless network status bar”, and the device status is “wireless network not connected”, the processor 104 may determine the second combination thereof corresponds to Case 6 in Table 2. In this case, the processor 104 may determine the second assisting suggestion to be “Do you need help opening the Wi-Fi settings page?”

In addition, if the processor 104 determines the interactive behavior of the input indicator is “staying”, the first content area is “accessory status bar”, and the device status is “device controller not connected”, the processor 104 may determine the second combination thereof corresponds to Case 7 in Table 2. In this case, the processor 104 may determine the second assisting suggestion to be “Hey, it seems you're not connected to the controller. Do you need help starting the pairing process?”

Next, the processor 104 may trigger the virtual assistant to provide the second assisting suggestion.

The mechanism of providing the second assisting suggestion may be referred to the embodiments associated with providing the first assisting suggestion.

Similarly, the processor 104 can also perform the first function and/or second function based on the confirmative response and/or intention response from the user.

In one embodiment, the first function may indicate changing a device status of the host 100. For example, the virtual assistant may ask, via the second assisting suggestion, the user if the user wants to change a device status (e.g., Wi-Fi status) of the host 100 if the determined second combination shows that the user may intend to change the device status of the host 100. In this case, the user may say “yes”, and the processor 104 may determine that a confirmative response to the second assisting suggestion has been detected. Accordingly, the processor 104 may execute the first function by changing the device status of the host 100, but the disclosure is not limited thereto.

The disclosure further provides a computer readable storage medium for executing the method for providing interactive assistance. The computer readable storage medium is composed of a plurality of program instructions (for example, a setting program instruction and a deployment program instruction) embodied therein. These program instructions can be loaded into the host 100 and executed by the same to execute the method for providing interactive assistance and the functions of the host 100 described above.

To sum up, the embodiments of the disclosure provide a solution to trigger the virtual assistant to provide an assisting suggestion if a combination of the interactive behavior of the input indicator and the first content area (and the device status of the host) corresponds to a predetermined combination. In this case, the solution can proactively trigger the virtual assistant to assist the user, which improves the operational convenience, thereby improving user experience.

It will be apparent to those skilled in the art that various modifications and variations can be made to the structure of the present invention without departing from the scope or spirit of the disclosure. In view of the foregoing, it is intended that the present disclosure cover modifications and variations of this invention provided they fall within the scope of the following claims and their equivalents.

What is claimed is:

1. A method for providing interactive assistance, executed by a host, comprising:
displaying a visual content, wherein the visual content comprises at least one content area;
determining an interactive behavior of an input indicator to the visual content;
determining a first content area currently interacting with the input indicator among the at least one content area;
in response to determining that a first combination of the interactive behavior of the input indicator and the first content area corresponds to a first predetermined combination among a plurality of predetermined combinations, retrieving a first assisting suggestion corresponding to the first predetermined combination; and
triggering a virtual assistant to provide the first assisting suggestion.

2. The method according to claim 1, further comprising:
in response to determining that the first content area corresponds to a device status indicator of the host, reading a device status corresponding to the device status indicator;
in response to determining that a second combination of the interactive behavior of the input indicator, the first content area, and the device status corresponds to a second predetermined combination among the plurality of predetermined combinations, retrieving a second assisting suggestion corresponding to the second predetermined combination; and
triggering the virtual assistant to provide the second assisting suggestion.

3. The method according to claim 1, wherein the first assisting suggestion suggests to execute a first function, and after triggering the virtual assistant to provide the first assisting suggestion, the method further comprises:
in response to detecting a confirmative response to the first assisting suggestion, executing the first function suggested by the first assisting suggestion.

4. The method according to claim 3, wherein the first function indicates launching a target application, and executing the first function comprises launching the target application.

5. The method according to claim 3, wherein the first function indicates changing a device status of the host, and executing the first function comprises changing the device status of the host.

6. The method according to claim 1, wherein after triggering the virtual assistant to provide the first assisting suggestion, the method further comprises:
in response to detecting an intention response to the first assisting suggestion, executing a second function corresponding to the intention response.

7. The method according to claim 1, wherein the at least one content area comprises at least one of an application library, a wireless network status bar, a Bluetooth status bar, a computing device connection status bar, a navigation panel button bar, an accessory status bar, a main field of a setting page, a subfield of the setting page, a store page, and a product description field.

8. The method according to claim 1, wherein the interactive behavior comprises at least one of staying, a point-to-point movement, a back-and-forth dragging movement, a movement with a fixed pattern.

9. The method according to claim 1, wherein the first assisting suggestion comprises a voice message.

10. The method according to claim 1, further comprising:
displaying an avatar of the virtual assistant in the visual content while providing the first assisting suggestion.

11. A host, comprising:
a non-transitory storage circuit, storing a program code; and
a processor, coupled to the non-transitory storage circuit and accessing the program code to perform:
displaying a visual content, wherein the visual content comprises at least one content area;
determining an interactive behavior of an input indicator to the visual content;
determining a first content area currently interacting with the input indicator among the at least one content area;
in response to determining that a first combination of the interactive behavior of the input indicator and the first content area corresponds to a first predetermined combination among a plurality of predetermined combinations, retrieving a first assisting suggestion corresponding to the first predetermined combination; and
triggering a virtual assistant to provide the first assisting suggestion.

12. The host according to claim 11, wherein the processor is further configured to perform:
in response to determining that the first content area corresponds to a device status indicator of the host, reading a device status corresponding to the device status indicator;
in response to determining that a second combination of the interactive behavior of the input indicator, the first content area, and the device status corresponds to a second predetermined combination among the plurality of predetermined combinations, retrieving a second assisting suggestion corresponding to the second predetermined combination; and
triggering the virtual assistant to provide the second assisting suggestion.

13. The host according to claim 11, wherein the first assisting suggestion suggests to execute a first function, and after triggering the virtual assistant to provide the first assisting suggestion, and the processor is further configured to perform:
in response to detecting a confirmative response to the first assisting suggestion, executing the first function suggested by the first assisting suggestion.

14. The host according to claim 13, wherein the first function indicates launching a target application, and the processor executes the first function by launching the target application.

15. The host according to claim 13, wherein the first function indicates changing a device status of the host, and the processor executes the first function by changing the device status of the host.

16. The host according to claim 13, wherein after triggering the virtual assistant to provide the first assisting suggestion, the processor is further configured to perform:
in response to detecting an intention response to the first assisting suggestion, executing a second function corresponding to the intention response.

17. The host according to claim 11, wherein the at least one content area comprises at least one of an application library, a wireless network status bar, a Bluetooth status bar, a computing device connection status bar, a navigation panel button bar, an accessory status bar, a main field of a setting page, a subfield of the setting page, a store page, and a product description field.

18. The host according to claim 11, wherein the interactive behavior comprises at least one of staying, a point-to-point movement, a back-and-forth dragging movement, a movement with a fixed pattern.

19. The host according to claim 11, wherein the first assisting suggestion comprises a voice message, and the processor is further configured to perform:
displaying an avatar of the virtual assistant in the visual content while providing the first assisting suggestion.

20. A non-transitory computer readable storage medium, the computer readable storage medium recording an executable computer program, the executable computer program being loaded by a host to perform steps of:
displaying a visual content, wherein the visual content comprises at least one content area;
determining an interactive behavior of an input indicator to the visual content;
determining a first content area currently interacting with the input indicator among the at least one content area;
in response to determining that a first combination of the interactive behavior of the input indicator and the first content area corresponds to a first predetermined combination among a plurality of predetermined combinations, retrieving a first assisting suggestion corresponding to the first predetermined combination; and
triggering a virtual assistant to provide the first assisting suggestion.
